(19) United States
(12) Patent Application Publication
(10) Pub. No.: US 2022/0372335 A1
(43) Pub. Date: Nov. 24, 2022

(54) TAPE WITH MULTIPLE SIDED ADHESIVE MATERIAL

(71) Applicants: Rahul Jindal, Bathinda, Punjab (IN); Rajan Gupta, Lehra Gaga, Punjab (IN)

(72) Inventors: Rahul Jindal, Bathinda, Punjab (IN); Rajan Gupta, Lehra Gaga, Punjab (IN)

(21) Appl. No.: 17/767,178

(22) PCT Filed: Oct. 16, 2020
(86) PCT No.: PCT/IB2020/059768

§ 371 Date: Apr. 7, 2022

(30) Foreign Application Priority Data
Oct. 18, 2019 (IN) 201911042423

(51) Int. Cl. C09J 7/20

(52) U.S. Cl. CPC C09J 7/201; C09J 2301/18; C09J 2301/204; C09J 2301/16

(57) ABSTRACT

An adhesive tape is disclosed that can simplify the process of pasting a torn, cut off, additional piece of material into its position. The adhesive tape comprising a strip that comprises of flaps made up of flexible material extending radially from a common axis along the length of the strip. The surfaces of the flap are either both adhesive surfaces or one adhesive surface and another is non-adhesive surface. The invention provides a removable layer which protects an adhesive quality of the adhesive surface on which corresponding removable layer is pasted. The invention also provides a method of easily tracing the removable layer which is pasted onto the tape which relates to the method to know the approximate/exact amount of tape left in a roll.

### CROSS-REFERENCE TO RELATED APPLICATION(S) AND PRIORITY

The present application claims priority from Indian Patent Application number 201911042423 filed on 18 Oct. 2019, incorporated herein by reference.

### FIELD OF THE INVENTION

The presently disclosed subject matter relates generally to the shape of an adhesive tape. More particularly, the present invention relates to a multiple sided adhesive material which can be used to simplify process of pasting a torn or cut off or additional piece of material into its position.

### BACKGROUND

As is commonly observed, whenever a user has to fix some torn or cut off piece or to seal some box from outside surface or to join two things together, common or specific adhesives tapes are used. Such tapes basically have an adhesive on one side or both sides of a flap or strip shaped material. In one instance, when a page is detached from a book, a user paste it back into its position by using ordinary tape, and it is done by pasting the page from one side first and then from the other side. In this instance, the taping has to be done from all sides separately to hold both, the page and the surface on which it is to be pasted, to paste it properly.

Similarly, on the other hand, when an object is to be joined with another object, such as to make 3d models or pasting hangings to the wall or other such things, it is common practice to use ordinary tape to paste or join these materials. In this instance, the user has to paste or join them from multiple angles and multiple times so as to give proper strength to them.

Similarly in other instances, especially where a tape is wound around the item several times - as an example, sealing a box—a large amount of tape with ordinary shape (adhesive on 1 out of 2 sides) is used to seal the item properly, and to give extra strength to the box on which it is applied, so as to protect the item from damages during its transition from one place to another.

As will be appreciated, the problem with above mentioned examples is that a large amount of ordinary tape is used and user has to spend more time and experiences difficulty while pasting, joining or packing some material. This is because the portion of material on which these tasks are to be performed includes multiple sides and the process has to be repeated on each side—leading to instances where the material loses it flexibility to rotate or turn freely as before.

In some instances, while sealing a box, user frequently experience certain challenges in sealing a box as the box gets sealed from outside only. This seal can be tampered as the taping is done from one side only, in addition to this the seal from outside only doesn't add-on to the strength of a box. If pressure is applied on the tear off section, the box may get damaged along with the item(s) present in it.

While this might be viewed as just an annoyance to a single-time user in pasting or sealing a single item, the problem becomes far more serious in a packaging department of a business, for example, where multiple numbers of items are to be packed as part of an industrial application.

As will be acknowledged, the situation discussed above resurges if no additional support is provided from the inside. A great deal of effort and time is employed in pasting a torn off material, joining two materials, sealing of boxes and many such things related with taping. Even if the process is completed once, the resurgence of same will require same amount of time, effort and material to finish as done before.

In addition to the above discussed problems, one another problem is with the quantitative approximation of adhesive tape left for use. As we know that most adhesives or non-adhesives tapes are provided in a roll format or strip format. These materials when used run out of their length and finally finishes. In cases where quantitative analysis of that material left is not available; like length of tape left, the user finds difficulty in analyzing the amount of material left before it gets finished. In certain cases, when the adhesive tape finishes, the user has to postpone the task to get a new one as without it the task can't be completed. This follows because the user didn't notice its length or didn't check the amount left in it before initiating the task. As will be acknowledged, the situation presents itself from time to time.

Therefore, it is desirable to provide a tape that overcomes the problems associated with the prior art described above.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

The present invention provides a new and improved shape of tape using which any taping action can be performed easily.

According to an object of the present invention, a tape comprising a strip is disclosed. The strip comprises a set of four flaps extending radially from a common axis parallel to longitudinal direction along the length of the strip. Each of the flaps comprises an adhesive surface and a non-adhesive surface.

According to another object of the present invention, a tape comprising a strip is disclosed. The strip comprises at least three flaps, extending radially from a common axis parallel to longitudinal direction along the length of the strip. Each of the flaps comprises at least one adhesive surface.

According to an object of the present invention, the tape when unrolled the strip is opened and separated into the flexible flaps in such a manner that the flaps defines longitudinally extending channels. Each of the flaps are arranged in a manner that the adhesive surface of each of the flaps is adjacent to the adhesive surface of one of neighbouring flaps and the non-adhesive surface of each of the flaps is adjacent to the non-adhesive surface of other of the neighbouring flaps.

The flexible characteristics of the flaps allows turning or rotation around the common axis when a pasted object is placed in between the adhesive surfaces of neighbouring flaps.

According to object of the invention, each of the adhesive surfaces and the non-adhesive surfaces are formed as a continuous layer of adhesive and non-adhesive material respectively.

According to another object of the invention, each of the adhesive surface comprises continuous pattern of adhesive and non-adhesive regions.

According to yet another object of the invention, each of the adhesive surface comprises non-continuous pattern of adhesive and non-adhesive regions.

According to yet another object of the present invention, the adhesive layers comprises an adhesive material to paste a torn or cut off or additional piece of material into its position.

According to yet another object of the present invention, the adhesive surface is composed of an acrylic pressure sensitive adhesive material.

According to an object of the invention, the flaps are having removable layers, wherein the removable layers protect adhesive quality of each of the adhesive surface on which corresponding removable layer is pasted.

According to another object of the invention, the removable layers can be made up of material selected from, but not limited to, transparent color, distributed color, printed pattern, or a combination thereof which is further used to differentiate the adhesive surface from the non-adhesive surface of the tape.

According to an object of the present invention, the removable layers comprises an extended portion to form an extended removable layers used to peel off the removable layers to expose the adhesive surface.

According to an object of the present invention, the extended removable layers can be made up of material, but not limited to, of transparent color, distributed color, printed pattern, or a combination thereof.

According to an object of the present invention, a method is disclosed such that the quantitative analysis of useable material left in a roll or a strip is easily done.

According to one embodiment, the quantitative analysis of useable material of the tape can be performed by analysing the intensity of the colors printed on the removable layers which when gradually decrease from high to low indicates the useable material left in a roll or a strip.

According to yet another embodiment, the strip can be designed of, but not limited to, transparent color, distributed color, printed pattern, or a combination thereof, thereby the intensity of the color printed on the strip gradually varies to indicate remaining strip in a roll.

According to an object of the present invention, the strip comprises a plurality of markings to tear off the strip easily from the tape.

The design of the plurality of markings comprises at least one of, but not limited to, punched, engraved, printed, or a combination thereof depending upon the type of material used in tapes or as per requirement.

In preferred embodiment, the tape is used to seal a box from both the inside and outside surface of the box.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates a tape according to the preferred embodiment and other features of the present invention.

FIG. 2A illustrates a cross-sectional view of the tape of the preferred embodiment illustrating four flaps.

FIG. 2B illustrates a cross-sectional view of the tape of another embodiment illustrating three flaps.

FIG. 2C illustrates a cross-sectional view of the tape of yet another embodiment illustrating six flaps.

FIG. 3 illustrates strip of the tape according to the preferred embodiment and other features of the present invention.

FIGS. 3A, 3B, 3C, 3D, 3E, 3F, and 3G illustrates various applications of the tape according to the present invention.

### DETAILED DESCRIPTION OF THE PREFERRED EMBODIMENT

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

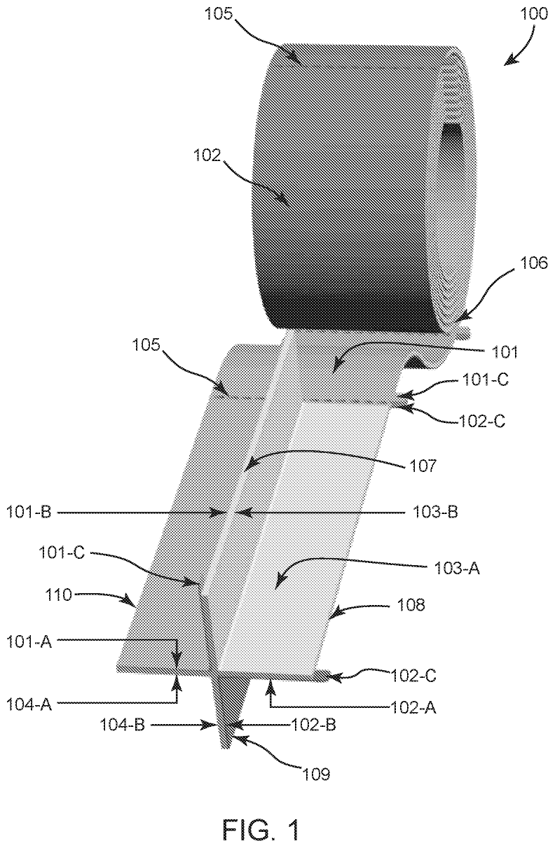

Referring now to the figures, wherein the components are labeled with like numerals throughout the several figures, and initially referring to FIG. 1, illustrates cross sectional view of the tape 100 according to the present invention. The tape 100 comprises a strip 106, wherein the strip comprises four flaps 107, 108, 109, and 110 extending radially from a common axis and longitudinally along the length of the strip 106 to form or define the X-shaped cross section. The flaps 107, 108, 109, and 110 are made up of a flexible material to allow turning or rotation around the common axis when a pasted object is placed in between the adjacent flaps. In preferred embodiment, the flaps extends radially from a center axis resulting into formation of flaps of same width. In another embodiment, at least one of the flap extends radially from any axis other than the center axis.

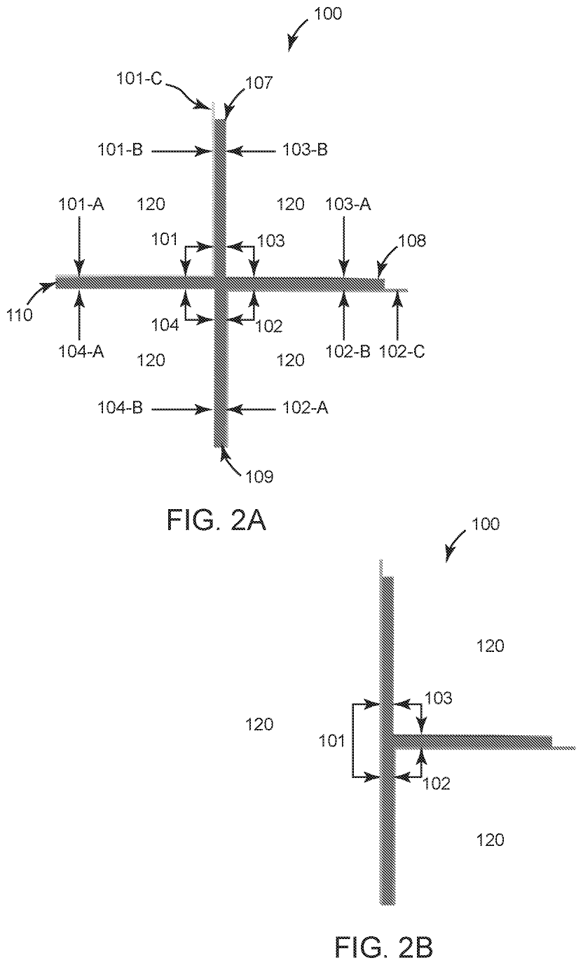

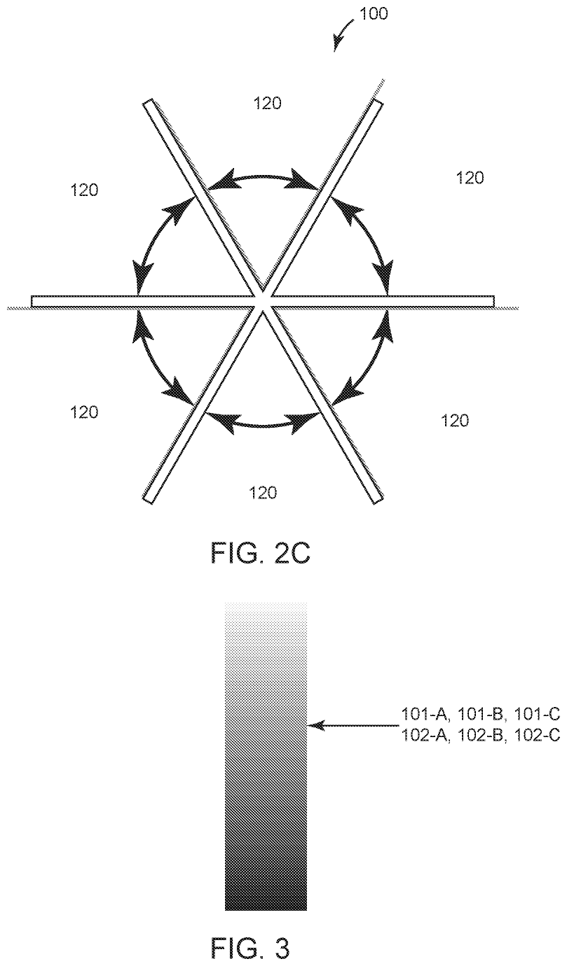

Referring to FIGS. 1 and 2A illustrating a preferred embodiment, the tape 100 unrolls into an X-shaped cross section by opening and separating the strip 106 into the four flaps 107, 108, 109, and 110, in such a manner that the four flaps defines four channels 120 extending longitudinally along a length of the strip 106. Each of the four flaps 107, 108, 109, and 110 has two opposite surfaces. Preferably, one surface of each of the flaps is adhesive surface and another opposite surface of each of the flaps is non-adhesive surface. In another embodiment, each of the flaps 107, 108, 109, and 110 have both surfaces of adhesive material. The adhesive and/or non-adhesive surfaces are oriented on the exterior surfaces of the strip 106 arrangement to define the four channels 120 having corresponding four surfaces 101, 102, 103 and 104. The surfaces 101 and 102 are adhesive in nature and correspondingly surfaces 103 and 104 are non-adhesive in nature. Hence, the adhesive surface 101 and 102 are arranged in a manner such that the adhesive surface of each of the flaps is adjacent to the adhesive surface of one of neighbouring flaps and similarly, the non-adhesive surface 103 and 104 are arranged in a manner such that the non-adhesive surface of each of the flaps is adjacent to the non-adhesive surface of other neighbouring flaps. The adhesive material of the adhesive surface provides magnetic tearability, non-gloss properties, and excellent binding property. In one embodiment, the adhesive surface is composed of an acrylic pressure sensitive adhesive material. Non-limiting examples of adhesives include, rosin derivatives, acrylic resins, synthetic rubber, and petroleum resins.

In preferred embodiment, each of the adhesive surfaces 101 and 102 and the non-adhesive surfaces 103 and 104 are formed as a continuous layer of adhesive and non-adhesive material respectively. In yet another embodiment, each of the adhesive surfaces and the each of the non-adhesive surfaces have continuous pattern of adhesive and non-adhesive regions. In yet another embodiment, each of the adhesive surfaces and the each of the non-adhesive surfaces have non-continuous pattern of adhesive and non-adhesive regions. Each adhesive surfaces 101 and 102 and non-adhesive surfaces 103 and 104 is having a more or less L-shaped cross-section such that each L-shaped surface defines the area each channel 120 contained therein.

Referring to FIG. 2A, the strip 106 according to the present invention, comprises surfaces 101-A, 101-B, 102-A, and 102-B representing a removable layer over the adhesive surfaces 101 and 102 respectively. The removable layers 101-A, 101-B, 102-A and 102-B has basic function to protect the adhesive quality of the adhesive surface on which it is pasted. The removable layers 101-A, 101-B, 102-A and 102-B can be pulled away to expose adhesive to which process of pasting a torn, cut off, or an additional piece of material into its position can be performed. The material of removable layers 101-A, 101-B, 102-A and 102-B described herein can be selected from a plurality of different available options, for example, but not limited to, transparent material, translucent materials, and opaque materials. Further, non-limiting examples of removable layers of the cross tape can include single colored material, multicolor material, glossy material, matter material, printed pattern or combination thereof. The removable layers are designed in a way to differentiate the adhesive surfaces from the non-adhesive surfaces.

In preferred embodiment, the strip 106 also comprises surfaces 103-A, 103-B, 104-A and 104-B representing the respective surface of the non-adhesive surfaces 103 and 104. In another embodiment, the surfaces 103 and 104 are adhesive in nature and 103-A, 103-B, 104-A and 104-B are corresponding removable layers of the adhesive surfaces 103 and 104.

In preferred embodiment, the removable layers 101-B and 102-B comprises an extended portion to form extended removable layers 101-C and 102-C respectively which may be used to peel off the removable layer 101-B and 102-B easily to expose the adhesive nature of the adhesive surface 101 and 102. Non-limiting examples of material of which extended removable layer 101-C and 102-C are made is of transparent material, translucent materials, and opaque materials. Further, non-limiting examples of extended removable layers can include single colored material, multicolor material, glossy material, matter material, printed pattern or combination thereof. In preferred embodiment, the material of removable layer and extended removable layer is same. In another embodiment, the material of removable layer and extended removable layer is different.

Again referring to FIG. 1, the strip 106 comprises a plurality of markings 105 along the length of the strip 106 which helps user to easily tear off the strip 106 of the tape 100 whenever required. The markings 105 may be a good guiding means, with plurality of tear off patterns on the strip which allows user to easily tear tape during use. The markings 105 may be formed by non-limiting designs such as punched, engraved, printed, or combination thereof depending upon the type of material used in tapes or as per requirement. Further, the colored markings 105 may be designed according to different market requirements for striking different types of solid styles, patterns, cartoon images, or combination thereof. Furthermore, one can combine multiple scales onto the tape 100 where use of periodic lines as distinguished by colors can provide a multitude of customized multiple scale measurements for use in any particular industry. Optionally, one can add promotional or other branding indicia on the tape during the course of the making process of the tape.

Although the tape 100 of the preferred embodiment illustrated in FIG. 2A includes four longitudinal channels 120, it is understood that the present invention is not limited to the X-shaped tape arrangement comprising four channels. Rather, the another embodiment contemplates other tape arrangements including, although not limited to, the strip to define as few as three channels or as many as six or more channels, depending upon the number of flaps required by the design of the tape. Referring to FIG. 2B, in one embodiment, the tape 100 arrangement defines three longitudinal channels formed by three flaps. In another embodiment as shown in FIG. 2C, the tape 100 arrangement defines six longitudinal channels formed by six flaps.

Having thus described at least one illustrative embodiment of the present invention where the different surfaces 101, 101-A, 101-B, 101-C, 102, 102-A, 102-B, 102-C, 103, 103-A, 103-B, 104, 104-A and 105 shows a particular arrangement of surfaces. However, those skilled in ordinary art will recognize that arrangement of the surfaces is not needed to be as shown and other surfaces may be added to, or replace, the ones as shown.

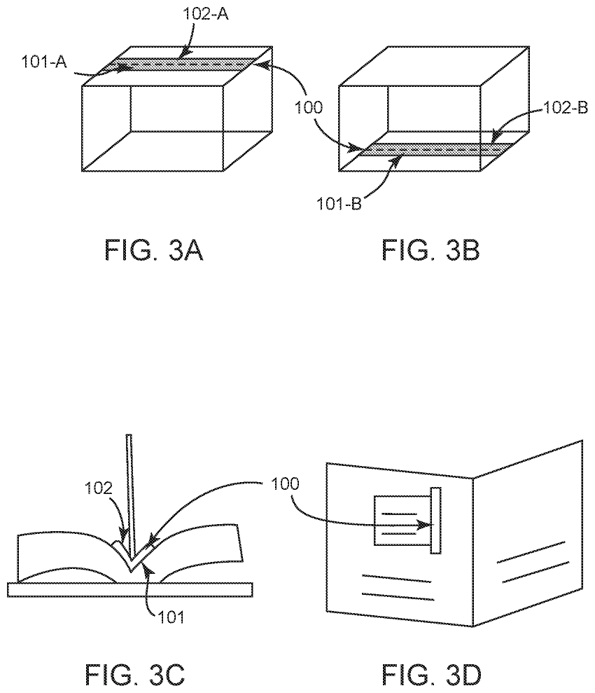

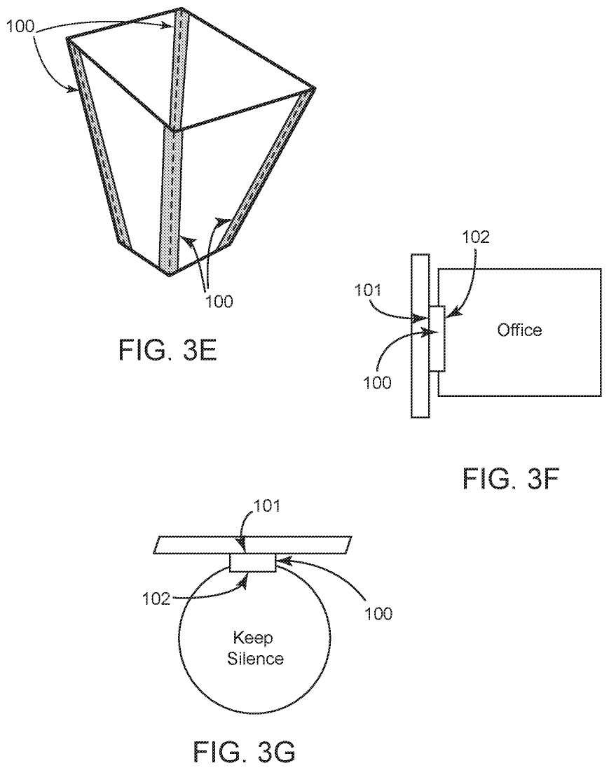

Referring to FIG. 3, according to the preferred embodiment of the present invention, the removable layers and the extended portion of the removable layers 101-A, 101-B, 101-C, 102-A, 102-B and 102-C are printed with a single or multicolor and varying the intensity of the color printed on the removable layers and the extended portion of the removable layers gradually varies to indicate remaining strip of the tape. For example, referring to FIG. 3, a single color is printed in a pattern such that the intensity of color decreases gradually from high to low. Following this color intensity, the user gets an estimate about the starting point, ending point and it also helps in locating the markings on the remainder of the tape 100 once the strip 106 is cut from it. For example, but not limited to, high color intensity represents full length of the tape and moving towards low color intensity represents usage of tape length and extremely low or no intensity represent end of the tape length. The tracing of the removable layers in such a manner provides a good guiding action which helps a user to identity approximate amount of the tape length left behind. Additionally, where a length of strip is cut from the tape and rest of tape is rolled back, the difference in intensity of color of removable layer at the surface below and above the markings of tape will help the user to locate the markings on the remainder of the tape. In another embodiment, the removable layer may have text printed on it along with length of tape left. One skilled in the art can adjust or add any color, print or any pattern of the removable layer in continuation with the present colors to obtain ideal results with respect to performing quantitative analysis of the tape. In another embodiment, rather than just removable layer, the mentioned innovative printing can be done on any of the other surfaces of the tape until the art behind the innovation remains same as discussed in various embodiments of the present invention. For example, the design of the strip 106 can include, but not limited to, single colored material, multicolor material, glossy material, matter material, printed pattern or combination thereof. Therefore, the gradual variation of the intensity of the color printed on the strip can also be used to indicate or measure the remaining strip in the tape.

The tape 100 of the present invention may be used in several areas including, but not limited to, closure applications, such as for sealing a box from both the inside and outside surface of the box; mounting applications, for example a wall-hanging, roof hangings, and bounding applications, for example for making different shapes and joining paper sheets and adding notes.

As shown in FIG. 3A and 3B, the tape 100 is being used to seal both the inside and the outside surfaces of the box at same instance of time. The arrangement of the tape 100 is such that the adhesive surface 101-A and 101-B gets attached to one fold of the box and the other adhesive surface 102-A and 102-B gets attached with the other fold of the box. Thereby, results into sealing a box from both the inside and the outside surfaces of the box. This arrangement of the tape provides extra strength to the box which prevents it from getting pressed from the top or bottom, thereby providing extra protection to the material present inside the box and prevents it from getting damaged.

Referring to FIG. 3C-3E, the tape 100 represents the bounding applications according to the present invention. As shown in FIG. 3C, the tape 100 is being used to simplify the process of pasting a new page into its position. The arrangement of the tape 100 is such that the adhesive surface 101 of the tape is being pasted on the bottom surface of book/copy and the other adhesive surface 102 gets attached to the new page, pasting it to the desired position in the book/notes and also providing it flexibility to turn as normal.

As shown in FIG. 3D, the tape 100 is being used to simplify the process of pasting an additional piece of paper into desired position. The arrangement of the tape 100 is such that the adhesive surface 101 (not shown) of the tape is being pasted on the bottom surface of book/copy and the other adhesive surface 102 (not shown) gets attached to the additional piece of paper, pasting it to the desired position and also providing it flexibility to turn as normal.

As shown in FIG. 3E, the tape 100 is being used to make shapes or models for creative purposes. For example, to make a rhombus shaped figure where four pieces of the strip has been used to hold four sides of rhombus.

Referring to FIG. 3F-3G, the tape 100 represents the mounting applications according to the present invention. As shown in FIG. 3F, the tape 100 is being used to simplify the process of pasting wall hangings onto the wall. The arrangement of the tape 100 is such that the adhesive surface 101 is being pasted on the wall and the other adhesive surface 102 gets attached to the wall hanging, pasting it to the desired position on wall and also providing it flexibility to turn as normal.

As shown in FIG. 3G, the tape 100 is being used to simplify the process of pasting roof hangings onto the roof. The arrangement of the tape 100 is such that the adhesive surface 101 is being pasted on the roof and the other adhesive surface 102 gets attached to the roof hanging, pasting it to the desired position on the roof and also providing it flexibility to turn as normal.

As understood by the person skilled in the art the tape according to the present invention can be used in any application for example, but not limited to, in copy and crafts, fabric and clothing, in automobile industry or furniture and appliance.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner Thus, scope of the invention is indicated by the following claims rather than by the foregoing description.

We claim:

1. A tape comprising a strip, wherein the strip comprises:
a set of four flaps extending radially from a common axis parallel to longitudinal direction along the length of the strip; and
wherein each of the flaps comprises an adhesive surface and a non-adhesive surface.

2. The tape of claim 1, wherein the set of four flaps are arranged in a manner that the adhesive surface of each of the flaps is adjacent to the adhesive surface of one neighbouring flap; and
the non-adhesive surface of each of the flaps is adjacent to the non-adhesive surface of other neighbouring flap.

3. The tape of claim 1, wherein the adhesive surface comprises a pattern of adhesive regions, non-adhesive regions or a combination thereof.

4. The tape of claim 1, wherein the strip comprises a removable layer on the adhesive surface to protect adhesive quality.

5. The tape of claim 4, wherein the removable layer comprises an extended portion used to peel off the removable layer thereby exposing the adhesive surface.

6. The tape of claim 4, wherein design of the removable layer is based on at least one of, but not limited to transparent color, distributed color, printed pattern, or a combination thereof.

7. The tape of claim 6, wherein intensity of color printed on the removable layer gradually varies to indicate remaining strip in a roll.

8. The tape of claim 1, wherein the strip comprises a plurality of markings to tear off the strip easily from a roll.

9. The tape of claim 8, wherein design of the plurality of markings comprises at least one of, but not limited to punched, engraved, printed, or a combination thereof.

10. The tape of claim 1, wherein design of the strip is based on at least one of, but not limited to transparent color, distributed color, printed pattern, or a combination thereof.

11. The tape of claim 1, wherein the tape is used to seal a box from both the inside surface and outside surface of the box.

12. A tape comprising a strip, wherein the strip comprises:
at least three flaps extending radially from a common axis parallel to longitudinal direction along the length of the strip; and
wherein each of the flaps comprises at least one adhesive surface.

13. The tape of claim 12, wherein at least three flaps are arranged in a manner that the adhesive surface of each of the flaps is adjacent to the adhesive surface of one of neighbouring flaps.

14. The tape of claim 12, wherein the adhesive surface comprises a pattern of adhesive regions, non-adhesive regions or a combination thereof.

15. The tape of claim 12, wherein the flaps are made up of a flexible material to allow turning or rotation around the common axis when a pasted object is placed in between the adhesive surfaces of neighbouring flaps.

16. The tape of claim 12, wherein the strip comprises a removable layer on the adhesive surface to protect adhesive quality.

17. The tape of claim 16, wherein the removable layer comprises an extended portion used to peel off the removable layer thereby exposing the adhesive surface.

18. The tape of claim 16, wherein design of the removable layer is based on at least one of, but not limited to transparent color, distributed color, printed pattern, or a combination thereof.

19. The tape of claim 18, wherein intensity of color printed on the removable layer gradually varies to indicate remaining strip in a roll.

20. The tape of claim 12, wherein the strip comprises a plurality of markings to tear off the strip easily from a roll.

21. The tape of claim 20, wherein design of the plurality of markings comprises at least one of, but not limited to punched, engraved, printed, or a combination thereof.

22. The tape of claim 12, wherein design of the strip is based on at least one of, but not limited to transparent color, distributed color, printed pattern, or a combination thereof.

23. The tape of claim 22, wherein intensity of color printed on the strip gradually varies to indicate remaining strip in a roll.

24. The tape of claim 12, wherein the tape is used to seal a box from both the inside surface and outside surface of the box.
